(19) United States
(12) Patent Application Publication
(10) Pub. No.: US 2013/0019184 A1
(43) Pub. Date: Jan. 17, 2013

(54) METHODS AND SYSTEMS FOR VIRTUAL EXPERIENCES

(71) Applicants: Stanislav Vonog, San Francisco, CA (US); Nikolay Surin, San Francisco, CA (US); Tara Lemmey, San Francisco, CA (US)

(72) Inventors: Stanislav Vonog, San Francisco, CA (US); Nikolay Surin, San Francisco, CA (US); Tara Lemmey, San Francisco, CA (US)

(73) Assignee: Net Power and Light, Inc., San Francisco, CA (US)

(21) Appl. No.: 13/546,906

(22) Filed: Jul. 11, 2012

Related U.S. Application Data
(60) Provisional application No. 61/506,168, filed on Jul. 11, 2011.

(51) Int. Cl. G06F 3/048

(52) U.S. Cl. 715/751

(57) ABSTRACT

Systems and methods for providing virtual experiences are disclosed. In one embodiment, a method for providing a virtual experience from a first participant to a recipient participant may comprise: receiving the virtual experience from a device of the first participant, the virtual experience including a virtual good component, an animation component, and an accompanying sound component, the animation component indicative of an idea the first participant intended to convey to the recipient participant; generating the animation component of the virtual experience, the animation component including a graphical animation of the virtual good component across displays of the first participant's device and the recipient participant's device; and providing the virtual experience to the recipient participant's device by spanning across the virtual good component and the animation component with a trajectory starting from a display of the first participant's device and ending on a display of the recipient participant's device.

### CROSS-REFERENCE TO RELATED APPLICATIONS

This application claims the benefit of U.S. Provisional Application No 61/506,168 entitled “Methods and Systems for Virtual Experiences”, filed Jul. 11, 2011, and is hereby incorporated by reference in its entirety.

### TECHNICAL FIELD

The field of the present disclosure relates generally to computer systems. In particular, the present invention is directed to a method and system for virtual experiences

### BACKGROUND

Virtual goods are non-physical objects that are purchased for use in online communities or online games. They have no intrinsic value and, by definition, are intangible. Virtual goods include such things as digital gifts and digital clothing for avatars. Virtual goods may be classified as services instead of goods and are sold by companies that operate social networks, community sites, or online games. Sales of virtual goods are sometimes referred to as microtransactions. Virtual reality (VR) is a term that applies to computer-simulated environments that can simulate places in the real world, as well as in imaginary worlds. Most current virtual reality environments are primarily visual experiences, displayed either on a computer screen or through special stereoscopic displays, but some simulations include additional sensory information, such as sound through speakers or headphones. Some advanced haptic systems now include tactile information, generally known as force feedback, in medical and gaming applications. FIGS. 1 through 3 provide examples of such prior availability of such virtual goods. For example, FIG. 1 is an example of Facebook® virtual goods (e.g., virtual cupcakes, virtual teddy bears, etc.) that can be exchanged between contacts of a social network. FIG. 2 is another example within a social media website (i.e., Farmville®), where participants exchange or handle virtual goods in a social environment. FIG. 3, illustrating an online social game, further adds to examples of virtual goods in the prior art.

### BRIEF DESCRIPTION OF DRAWINGS

These and other objects, features and characteristics of the present disclosure will become more apparent to those skilled in the art from a study of the following detailed description in conjunction with the appended claims and drawings, all of which form a part of this specification. In the drawings:

FIG. 1 is an example of Facebook® virtual goods that can be exchanged between contacts of a social network.

FIG. 2 is another example within a social media website (i.e., Farmville®), where participants exchange or handle virtual goods in a social environment.

FIG. 3 illustrates another example of virtual goods in an online social game.

FIG. 4 illustrates an exemplary overall block diagram of the virtual experience platform according to one embodiment(s) of the present disclosure.

FIGS. 5-7 illustrate an exemplary embodiment of several participants connected with respect to an everyday activity in accordance with another embodiment(s) of the present disclosure.

FIG. 8 illustrates, for example, an asynchronous setup of a virtual experience platform in accordance with yet another embodiment(s) of the present disclosure.

FIGS. 9-10 illustrate examples of physical gestures for activation or effectuation of virtual experiences in accordance with yet another embodiment(s) of the present disclosure.

FIG. 11 illustrates a scenario where multiple participants watch a TV game together over, for example, a social media platform in accordance with yet another embodiment(s) of the present disclosure.

FIGS. 12-14 illustrate a soccer event that is simultaneously watched by several participants in accordance with yet another embodiment(s) of the present disclosure.

FIGS. 15-16 illustrate different types of animation in accordance with yet another embodiment(s) of the present disclosure.

FIG. 17 shows an environment with multiple participants participating in a virtual experience by means of various virtual features in accordance with yet another embodiment(s) of the present disclosure.

FIG. 18 illustrates various operations such as purchase, payment processing, receiving virtual experience requests, transfer of virtual experience across various other devices in accordance with yet another embodiment(s) of the present disclosure.

FIG. 19 illustrates pools of virtual machines that are allocated and preconfigured for various processing services related to the various animation rendering and other such virtual experience activities in accordance with yet another embodiment(s) of the present disclosure.

FIG. 20 illustrates cloud rendering operations where various animation tasks are split among virtual machines of a cloud computing network in accordance with yet another embodiment(s) of the present disclosure.

FIG. 21 illustrates an animation workflow for rendering various animation tasks related to delivering virtual experiences in accordance with yet another embodiment(s) of the present disclosure.

FIG. 22-23 illustrate exemplary flow charts of workflows of creating and optimizing virtual experiences that may be integrated with the virtual experience engine in accordance with yet another embodiment(s) of the present disclosure.

FIG. 24 illustrates an exemplary setup of base tools utilized in a virtual animation engine in accordance with yet another embodiment(s) of the present disclosure.

FIG. 25 illustrates additional details on animation rendering and further optimizing the created setup based on target devices where the animation is to be rendered, in accordance with yet another embodiment(s) of the present disclosure.

FIGS. 26-27 illustrate additional optimization examples based on the direction at which certain virtual experiences are aimed, and ensuring that trajectories and other dimensionalities associated with the aiming are efficiently translated based on the specific target device, in accordance with yet another embodiment(s) of the present disclosure.

FIGS. 28-29 illustrate additional optimization examples that involve handling (e.g., resizing, changing file type, adapting resolution values, etc.) of images and other embodiments associated with virtual experiences based on target devices and availability of computing capabilities, in accordance with yet another embodiment(s) of the present disclosure.

FIGS. 30 and 31 illustrate exemplary workflows of animation rendering and optimization to account for computing availability and based on ‘target device specifications, in accordance with yet another embodiment(s) of the present disclosure.

FIGS. 32 illustrates an exemplary block diagram of the architecture for a virtual experience server that can be utilized to implement the invention disclosure discussed herein, in accordance with yet another embodiment(s) of the present disclosure.

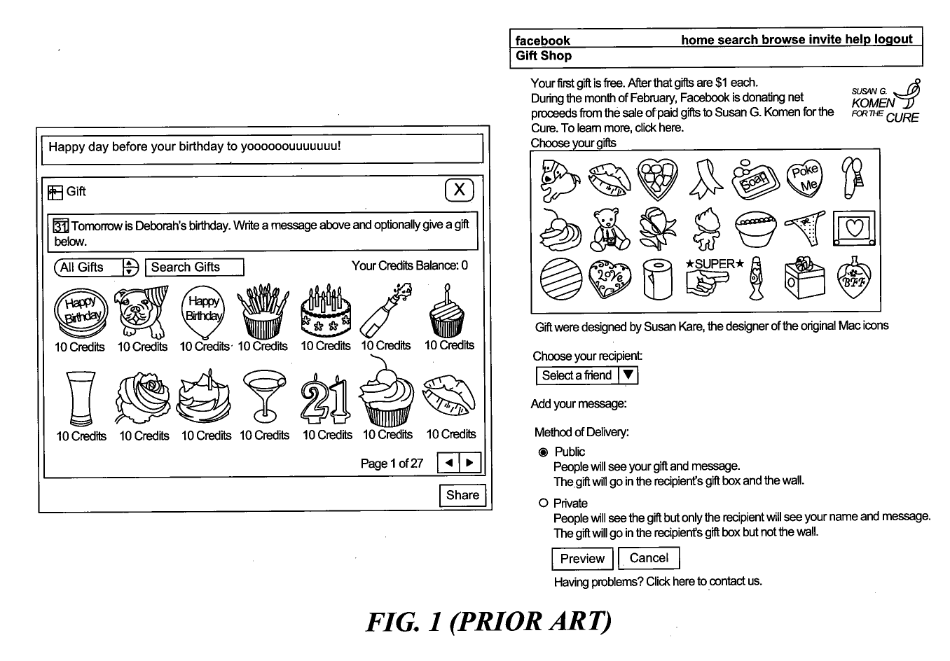

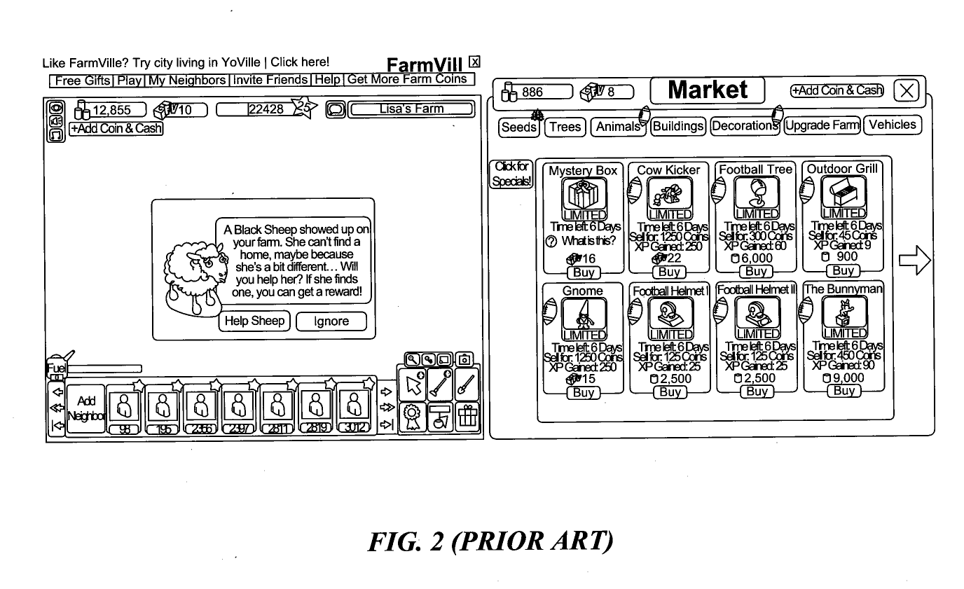

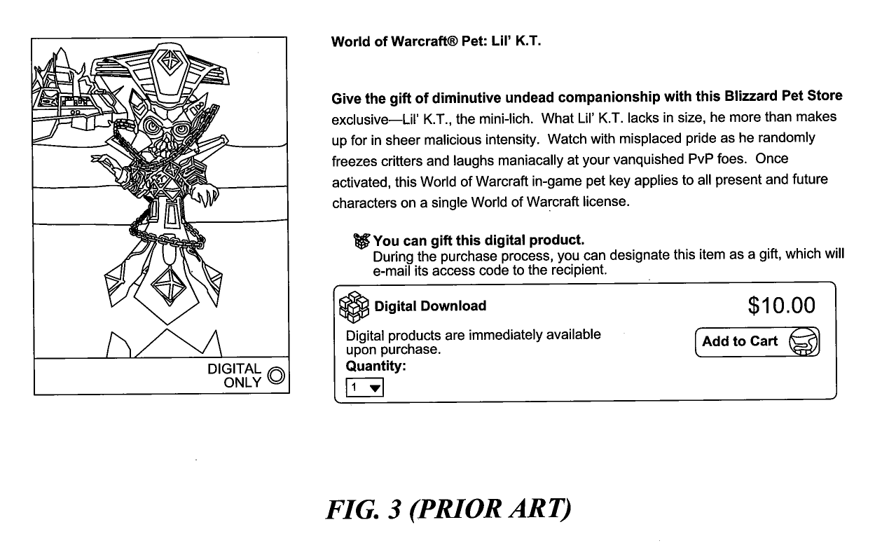

### DETAILED DESCRIPTION

Various examples of the present disclosure will now be described. The following description provides specific details for a thorough understanding and enabling description of these examples. One skilled in the relevant art will understand, however, that the present disclosure may be practiced without many of these details. Likewise, one skilled in the relevant art will also understand that the present disclosure can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

According to one embodiment of the present system, virtual goods may be evolved into virtual experiences. Virtual experiences may expand beyond limitations imposed by virtual goods by adding additional dimensions to the virtual goods. By way of example, Participant A using a mobile device transmits flowers as a virtual experience to Participant B accessing a second device. The transmission of the virtual flowers may be enhanced by adding emotion by way of sound, for example. The virtual flowers may also be changed to a virtual experience when Participant B can do something with the flowers. For example, Participant B can affect the flowers through any sort of motion or gesture. Participant A can also transmit the virtual goods to Participant B by making a “throwing” gesture using a mobile device, so as to “toss” the virtual goods to Participant B.

Some key differences from prior art virtual goods and the virtual experiences of the present application may include, for example, physicality, togetherness, real-time, emotion, response time, etc. of the portrayed experience. For example, when a participant wishes to throw a rotten tomato at a video/image that is playing over a social media (in a large display screen in a room that has several participants with personal mobile devices connected to the virtual experience platform) as part of a virtual experience, he may, in the illustrative example, portray the physical action of throwing a tomato (after choosing a tomato that is present as a virtual object) by using physical gestures on his screen. This physical action may cause a tomato to move from the participant's mobile device in an interconnected live-action format, where the virtual tomato first starts from the participant's device, pans across the screen of the participant's mobile device in a direction of the physical gesture, and after leaving the boundary of the screen of the participant's mobile device, is then shown as hurling across through the central larger screen (with appropriate delays to enhance reality of the virtual experience), and finally be splotched on the screen with appropriate virtual displays. The direction and trajectory of the transferred virtual object may be dependent on the physical gesture (in this example).

In addition to the visual experience, accompanying sound effects may further add to the overall virtual experience. For example, when the “tomato throw” starts from the participant's mobile device, a swoosh sound first emanates from the participant's mobile device and then follows the visual cues (e.g., sound is transferred to the larger device when visual display of tomato first appears on the larger device) to provide a more realistic “tomato throw” experience.

In some embodiments, a virtual experience may include a virtual goods component, an animation component, and an accompanying sound component. The animation component and/or the virtual goods component may be indicative of an idea a transmitting participant intended to convey to a recipient participant.

While this example illustrates a very elementary and exemplary illustration of virtual experiences, such principles can be ported to numerous applications that involve, for example, emotions surrounding everyday activities, such as watching sports activities together, congratulating other participants on personal events or accomplishments on a shared online game, etc. Such transfer of emotions and other such factors over the virtual experiences context may pan over multiple computing devices, sensors, displays, displays within displays or split displays, etc. The overall rendering and execution of the virtual experiences may be specific to each local machine or may all be controlled overall over a cloud environment (e.g., Amazon® cloud services), where a server computing unit on the cloud maintains connectivity (e.g., using APIs) with the devices associated with the virtual experience platform. The overall principles discussed herein are directed to synchronous and live experiences offered over a virtual experience platform. Asynchronous experiences are also contemplated as will be discussed further below. Synchronization of virtual experiences may pan across displays of several devices, or several networks connected to a common hub that operates the virtual experience. Monetization of the virtual experience platform is envisioned in several forms. For example, participants may purchase virtual objects that they wish to utilize in a virtual experience (e.g., purchase a tomato to use in the virtual throw experience), or may even purchase virtual events such as the capability of purchasing three tomato throws at the screen. In some aspects, the monetization model may also include use of branded products (e.g., passing around a 1-800-Flowers® bouquet of flowers to convey an emotional experience, where the relevant owner of the brand may also compensate the platform for marketing initiatives. Such virtual experiences may pan from simple to complex scenarios. Examples of complex scenarios may include a virtual birthday party or a virtual football game event where several participants are connected over the Internet to watch a common game or a video of the birthday party. The participants can see each other over video displays and selectively or globally communicate with each other. Participants may then convey emotions by, for example throwing tomatoes at the screen or by causing fireworks to come up over a momentous occasion, which is then propagated as an experience over the screens.

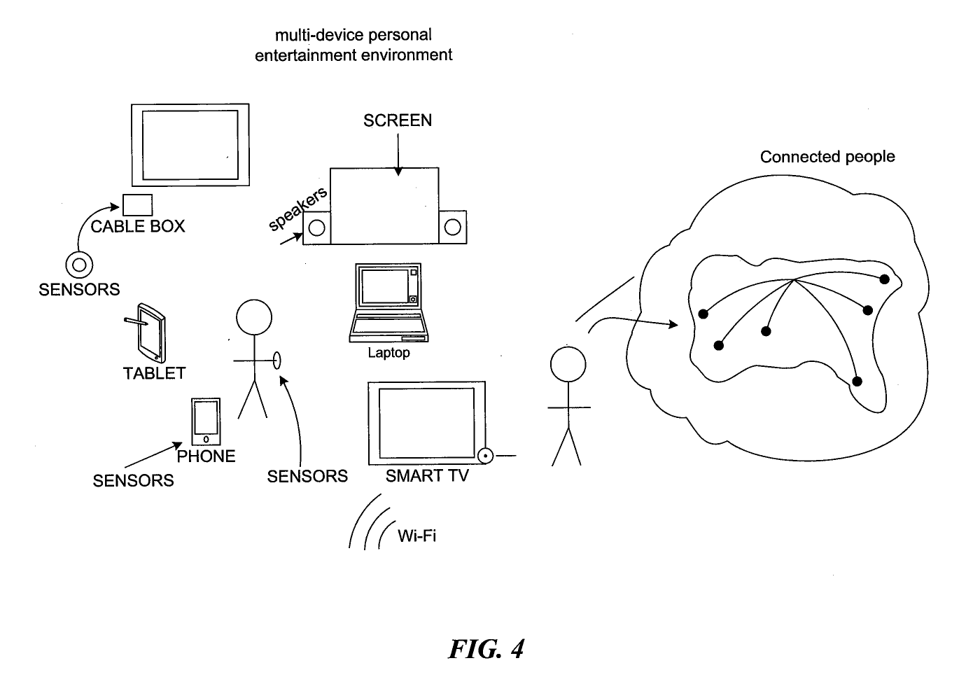

An exemplary overall block diagram of the virtual experience platform is provided in FIG. 4, where several participants are connected to a common social networking event (e.g., watching a football game together virtually connected on a communication platform). FIG. 4 represents a scenario of a synchronous virtual experience environment. Each participant has a sensor (e.g., a remote control, an iPhone® device, etc.) to be able to convey physical gestures. The devices (e.g., smart TVs, large computer screens etc.) are capable of receiving and displaying virtual experiences associated with the gestures as a result of being connected to the common virtual experience cloud (for example).

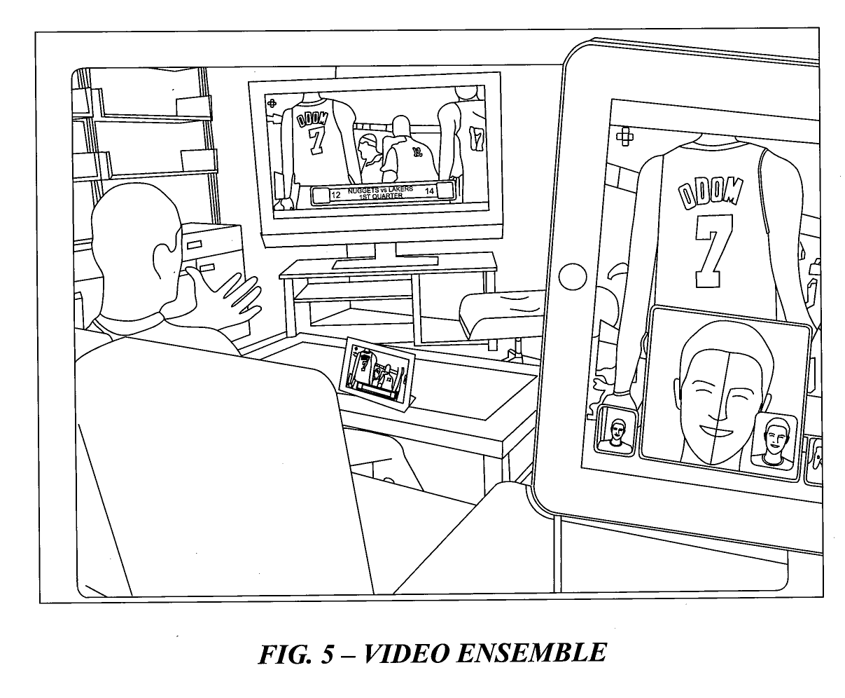

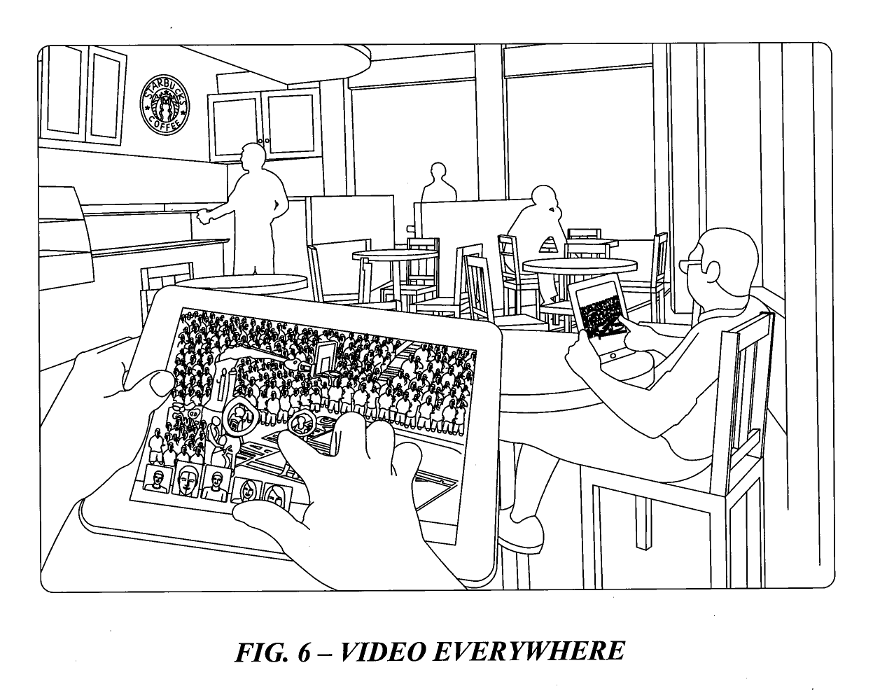

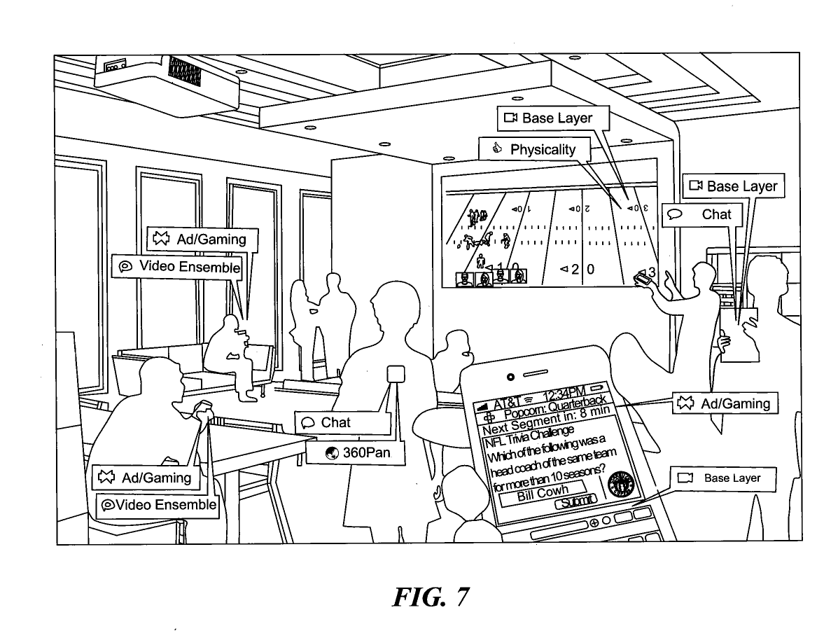

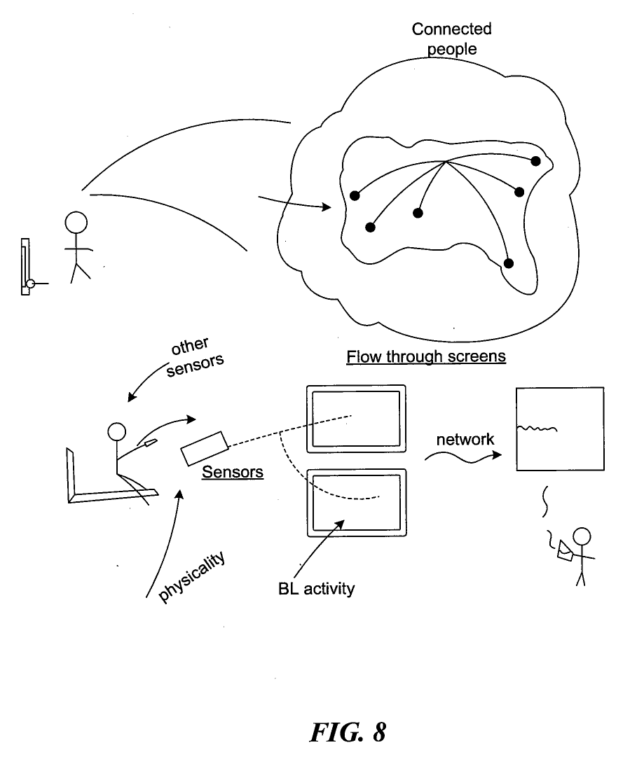

FIGS. 5-7 illustrate an exemplary embodiment of several participants connected with respect to an everyday activity, such as watching a football game. As illustrated in the examples, the virtual experiences pans across multiple devices and device types, including smart phones, entertainment devices, etc. In a synchronized setup, a cloud based server computing unit may receive and coordinate any virtual experience event (such as throwing a tomato) and controls it across all the pertinent devices. FIG. 8 illustrates, for example, an asynchronous setup of a virtual experience platform. When a request for a virtual experience is received, in one embodiment, the system may look within the local device to determine whether the requested content is available. If not, the cloud may coordinate the requested content and then effectuate the virtual experience across display(s) of the relevant one or more devices.

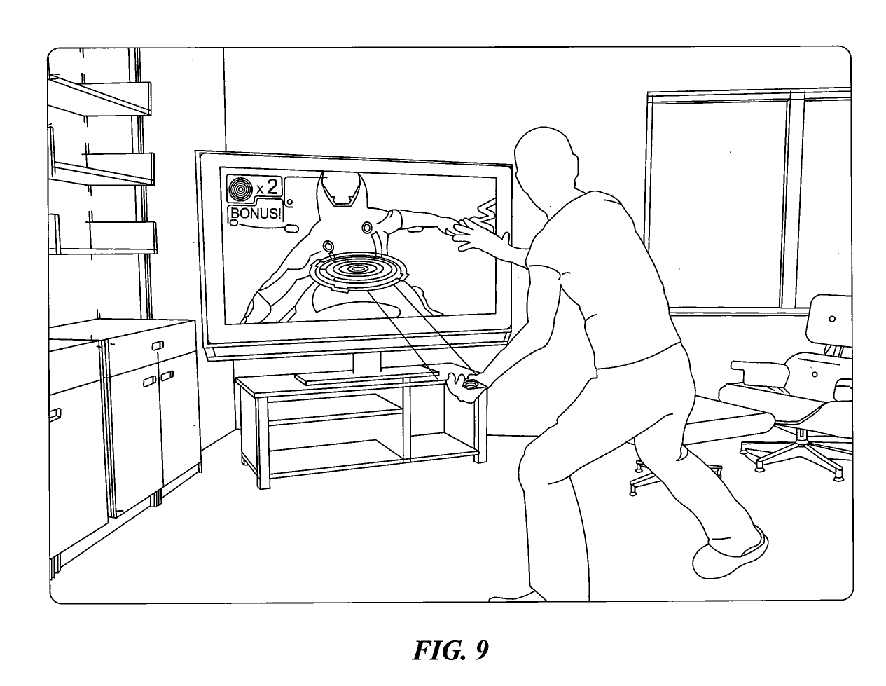

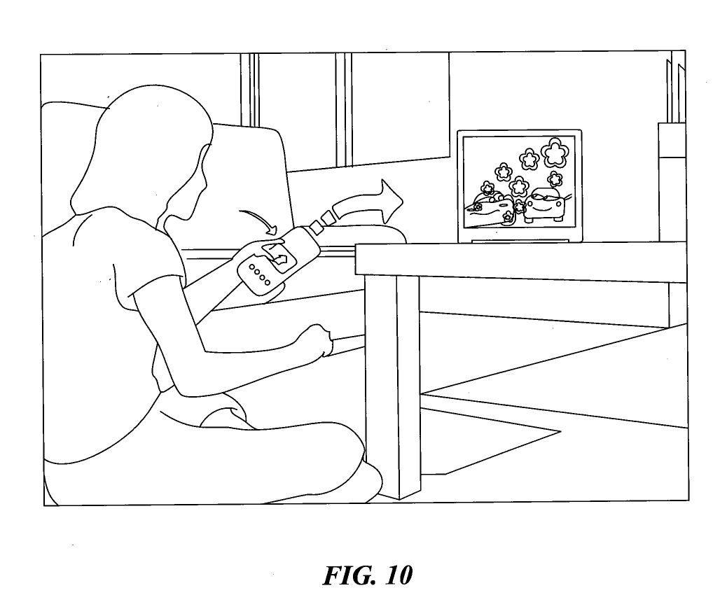

FIGS. 9-10 depicts examples of physical gestures for activation or effectuation of virtual experiences. As illustrated, such experiences can be activated by, for example, a physical motion in conjunction with an iPhone® smart phone device. In some examples, instead of a physical-gesture based activation, activation may be effected by controlling certain buttons or keys on mobile devices. FIG. 9 illustrates a virtual experience in a gaming application where the participant mimics the virtual experience of throwing a disc at an object on the screen by simulating the throwing as a physical gesture using the personal computing device. In return, the asynchronous or synchronous setup proceeds to render the disc and analyze (using, for example, motion sensors inherent to the controller) a direction of throw and a trajectory of throw, and accordingly effectuate the virtual experience. Similar principles are illustrated in FIG. 10 with respect to another virtual experience where a participant watching a video with other online participants shows her praise for a particular scene by throwing flowers on the screen.

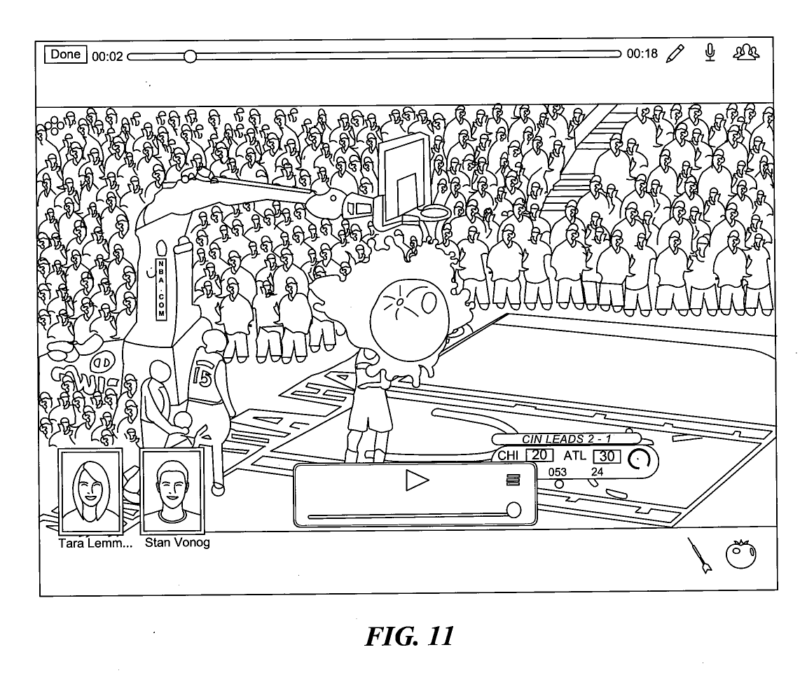

While there are numerous virtual experiences that can effectively utilize the principles discussed herein, the following sections detail the experiences associated with targeted virtual experiences. A first example, described in FIG. 11 describes a scenario where multiple participants watch a TV game together over, for example, a social media platform. When a participant virtual experience, such as a tomato thrown by another participant is received on the current participant's screen, a virtual experience may be provided by a swoosh noise following the trajectory of the throw within the screen, and also emulating the splotching of the tomato and dripping of the splotched content to further enhance the reality of the virtual experience.

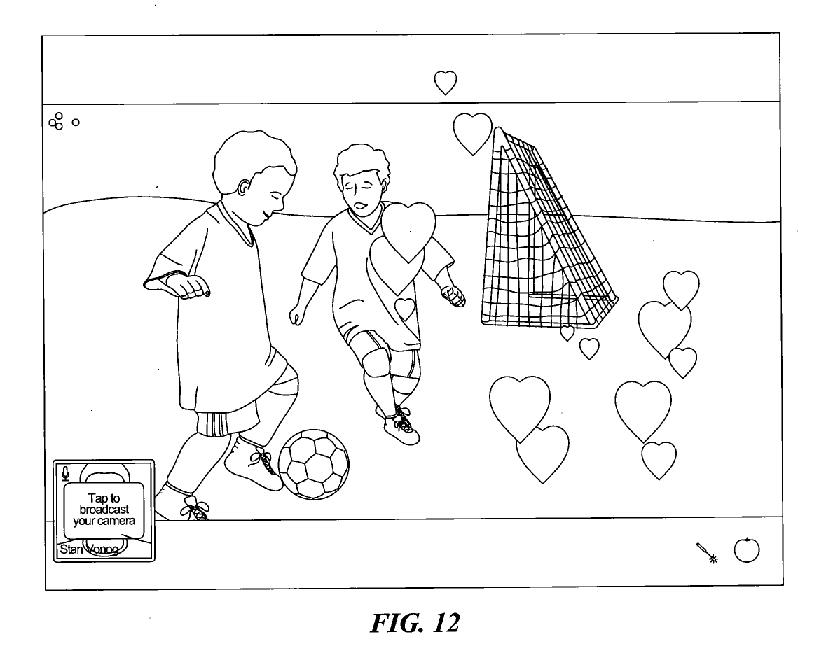

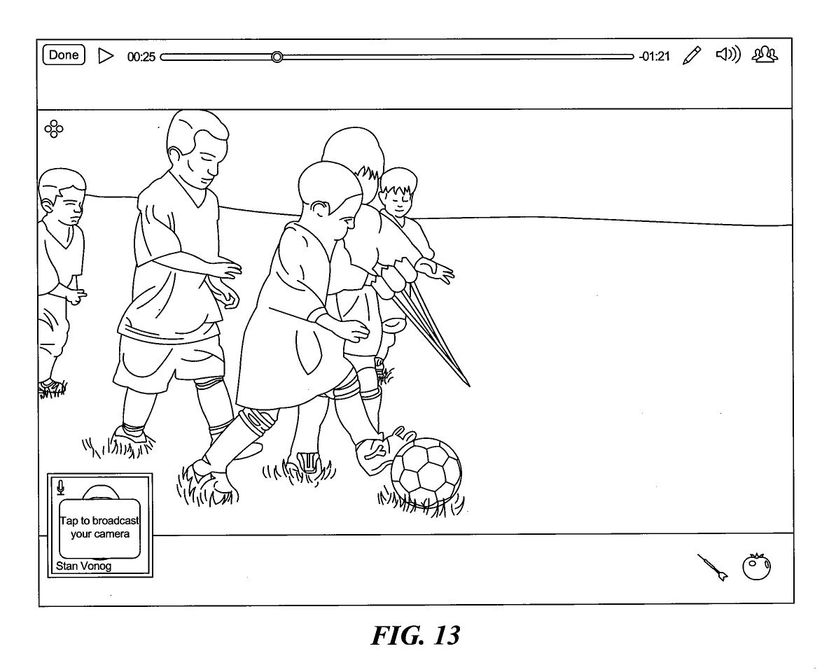

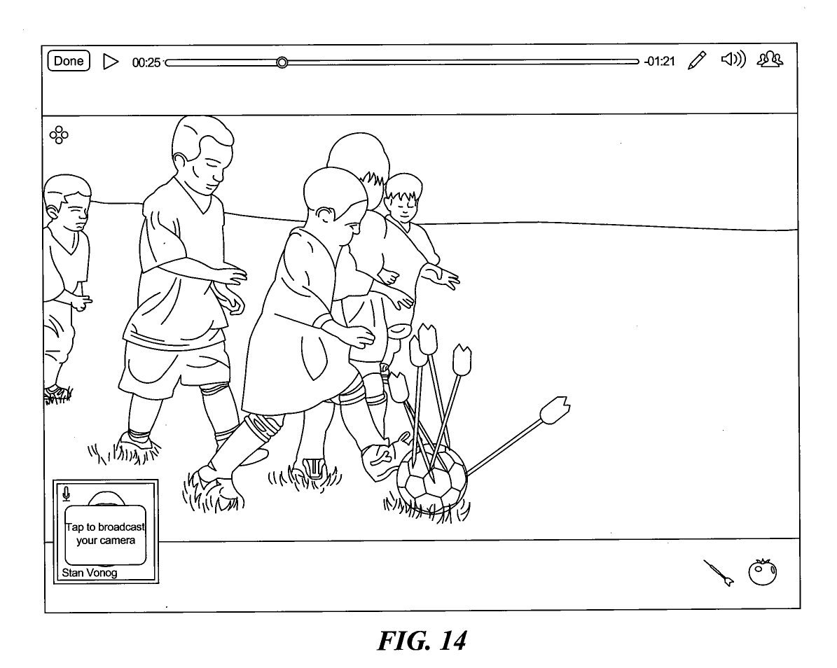

FIGS. 12-14 depict another such example, here of a birthday party or a child's soccer game video being simultaneously watched by several participants. A participant may show appreciation by throwing hearts on the screen, or by throwing flowers. The reality of the virtual experience is further enhanced by having the flowers hit the desired object at a desired trajectory and further having the flowers drop off relative to the position at which the flowers are directed to the screen. In some embodiments, the trajectory may be provided according to a characteristic of the virtual goods. In some implementations, options may be provided to select a desired trajectory for virtual goods from a plurality of predetermined trajectories. In addition to those experiences, as depicted in the figures, participant's live video may also be displayed so participants can communicate over the video in real time. Various controls related to video and text chat features in such a collaborative environment are also further contemplated.

### Virtual Engine

The above description discussed various examples of virtual experiences and a platform that provides synchronous or asynchronous mechanisms for providing such a virtual engine. The description now focuses on the virtual engine that enables such a virtual experience platform. In the prior art, products such as Adobe Flash®, HTML5 3D game animation engines (i.e., Unity®, Crytek®, etc.) were available as potential engineers to provide animation. The key ideas behind a virtual animation engine include provision of high quality animation on a mobile device/screen with limited processing capabilities. In addition to these capabilities, the virtual engine also will have to work other everyday experiences, unlike prior art game engines that assume they will render the whole environment. The devices used for virtual experiences may have limited processing capabilities, especially smart phones that have to use their resources for regular communication capabilities, etc. Accordingly, in embodiments, the virtual engine may utilize a cloud computing environment for the various rendering activities.

In some embodiments, a modeled environment that uses execution-capability of clients by splitting the execution task over the multiple clients (based on their cached availability, for example), may also be utilized for rendering. A purely local execution and rendering environment may be used where performance and instant or seamless delivery is expected. If such local execution is unavailable or is not an option, the local capabilities may be combined with cloud computing capabilities. If limited capabilities are present, then execution or rendering may be split in a selected manner. For example, in embodiments, if a virtual object related to a virtual experience or the virtual experience itself is purchased (as opposed to using something already in a cache), rendering/execution related to the purchase may be performed locally or within a local network and remaining rendering may be performed over the cloud.

In some embodiments, rendering of animations with respect to a virtual experience may be performed over a cloud. For example, in an illustrative environment where one participant throws a tomato on a screen, another participant may be able to receive the thrown tomato on his screen, but may not be able to throw it back or throw another tomato until buying such a tomato. Here, the purchase processing may be performed locally, but the animation rendering related to the animation of the tomato swooshing across the screen and splotching on the screen on a desired target is all performed over the cloud. Each of the connected devices include codecs (e.g., SENTIO codes as defined in U.S. patent application Ser. No. 13/165,710 entitled “Just-In Time Transcoding of Application Content,” which is incorporated herein by reference in its entirety) for direct connection with servers over the cloud and for transparency with the cloud computing environment.

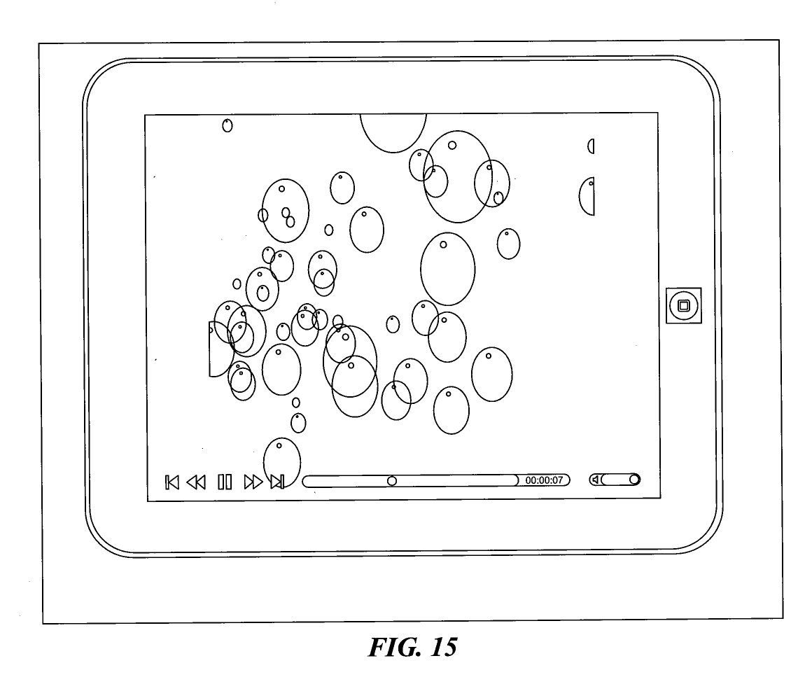

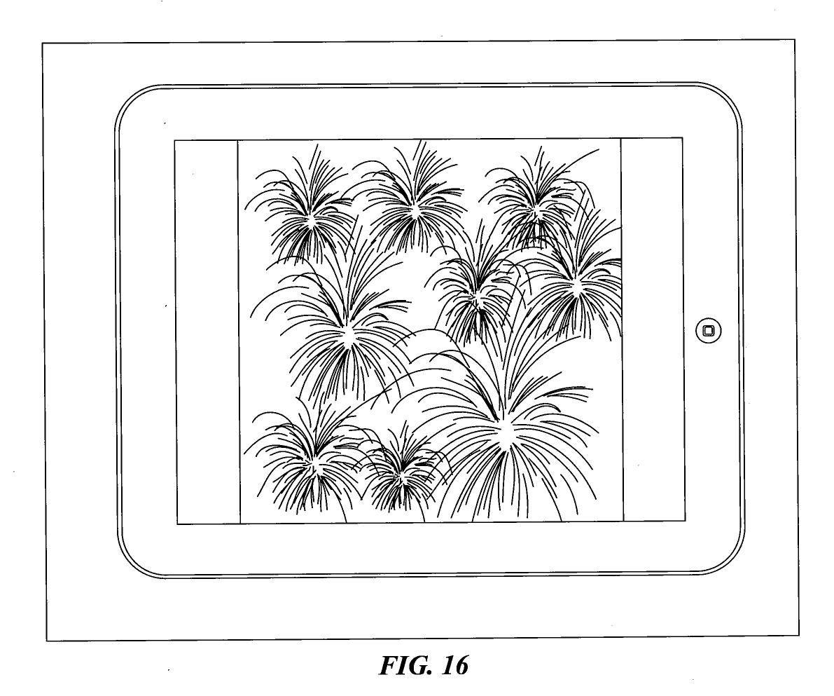

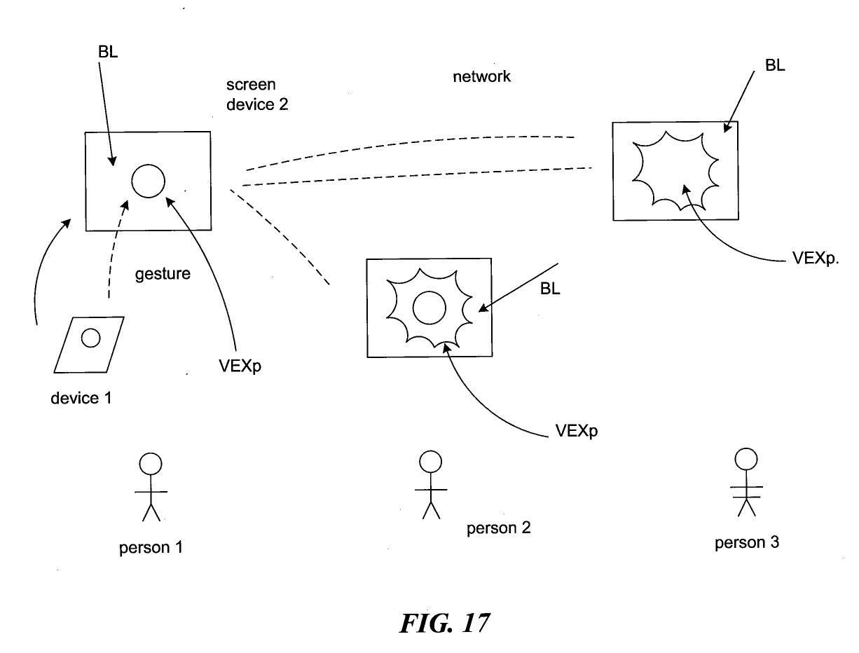

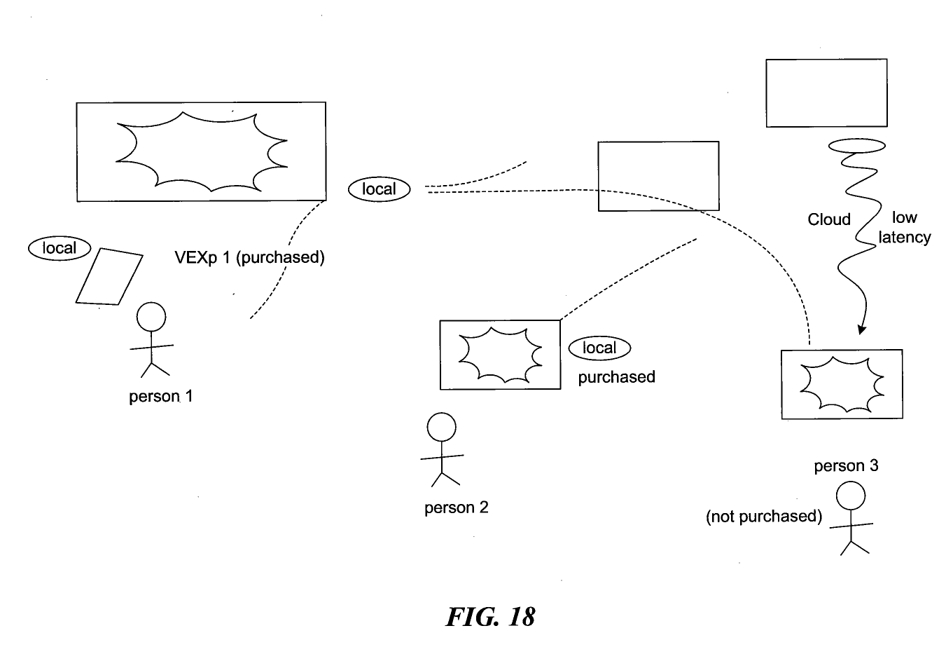

FIGS. 15-16 depict different types of animation. FIGS. 17-29 depict principles of operations of rendering with respect to the virtual engine. FIG. 17 shows an environment with multiple participants participating in a virtual experience by means of various virtual features explained above in this application. FIG. 18 depicts various operations such as purchase, payment processing, receiving virtual experience requests, and transfer of virtual experience across various other devices. Here, animations related to the virtual experiences are performed on the cloud while the more immediate processing features (e.g., payment processing, purchase of virtual features), etc. are performed locally. The cloud rendering is optimized for various low-latency features. Examples of low latency processing are abundant, but the inventors refer to application Ser. No. 13/165,710, referenced above, for additional low latency features to provide seamless animation rendering and delivery to other devices. In some embodiments, each participant' device may have a base content layer on its display. The base content layer may represent a live or prerecorded game that participants are engaged. In some embodiments, animations related to the virtual experiences may be displayed on the base content layer.

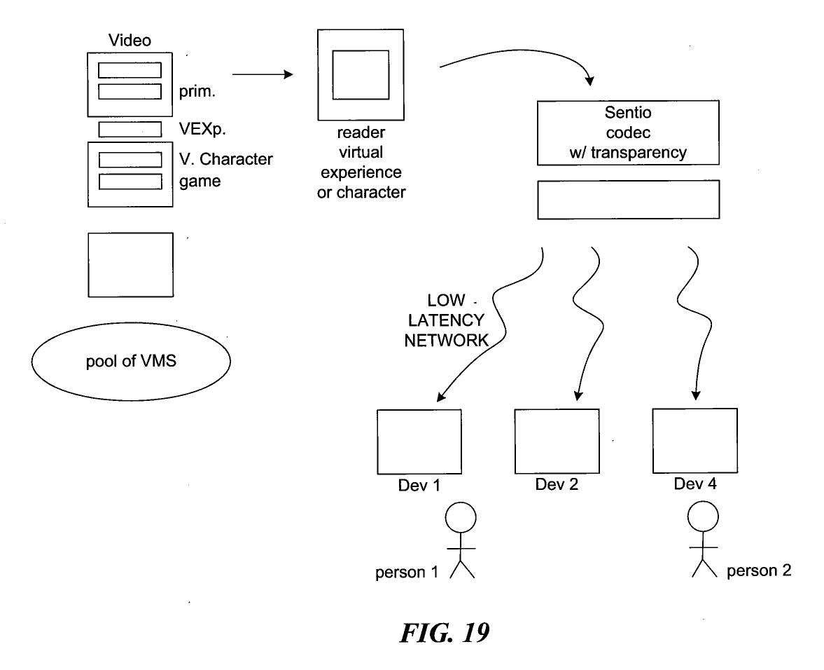

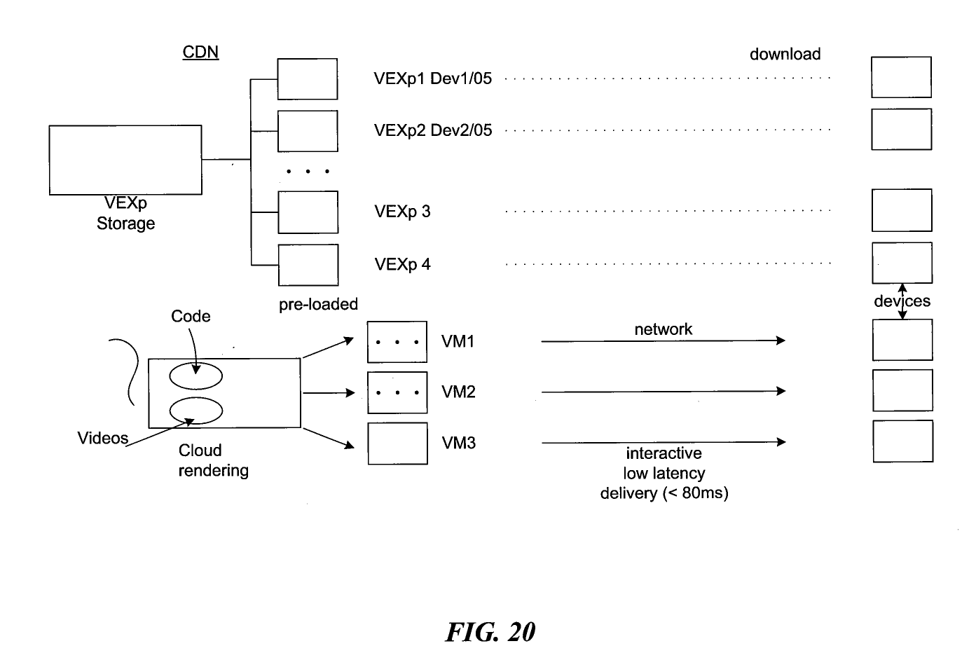

FIG. 19 depicts pools of virtual machines that are allocated and preconfigured for various processing services related to the various animation rendering and other such virtual experience activities. This setup further discloses the use of Sentio codecs that allow the various client devices to communicate with the cloud network in a low-latency network setup. A plurality of Sentio codecs may be provided for encoding and decoding virtual experience data streams that are related to a virtual experience. In some embodiments, the plurality of Sentio codecs may include an audio codec, a video codec, a gesture command codec, a sensor data codec, and/or an emotional codec. In some embodiments, when encoding the virtual experience data streams, the Sentio codec may take into account various factors, for example, available bandwidth, a characteristic of an intended recipient device, a characteristic of the virtual experience; and a characteristic of a transmission device etc. FIG. 20 further explains the cloud rendering operations where various animation tasks are split among virtual machines of a cloud computing network.

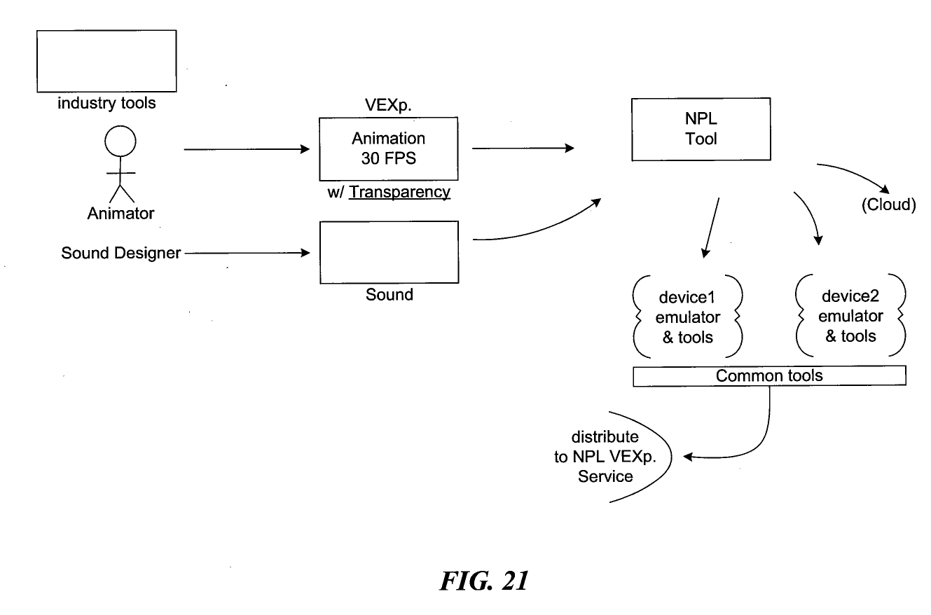

FIG. 21 illustrates an animation workflow for rendering various animation tasks related to delivering virtual experiences. An animator utilizes industry tools (e.g., Maya®, AfterEffects®, Pixar RenderMan®) to create animations related to various virtual experiences and incorporate such virtual experiences within the overall virtual experience platform. The animation format may be frame based to enable delivery of “real” virtual experiences. Such a rendering engine capability allows creation of a variety of virtual experiences that may be utilized in conjunction with the rendering engine.

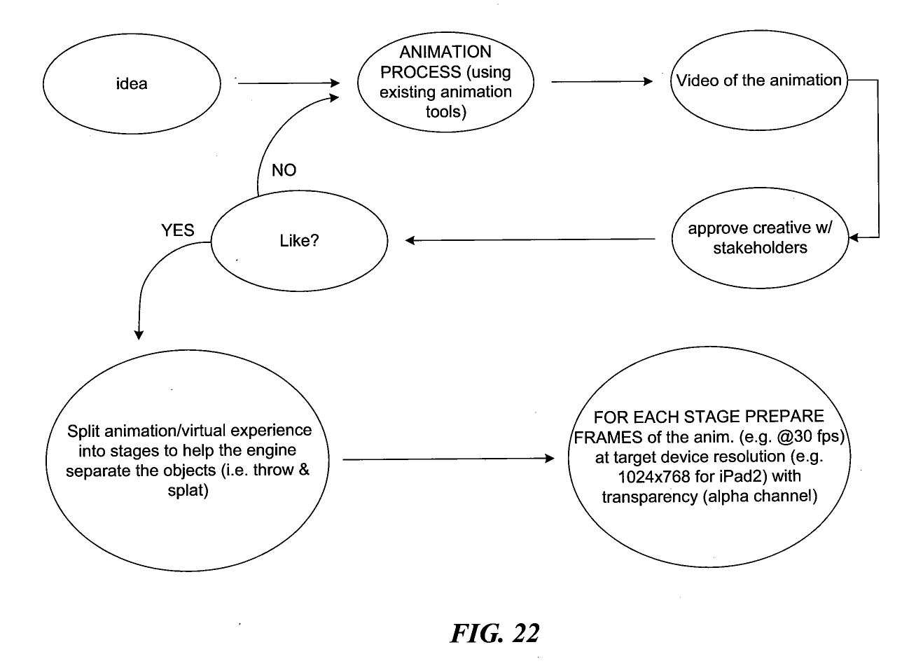

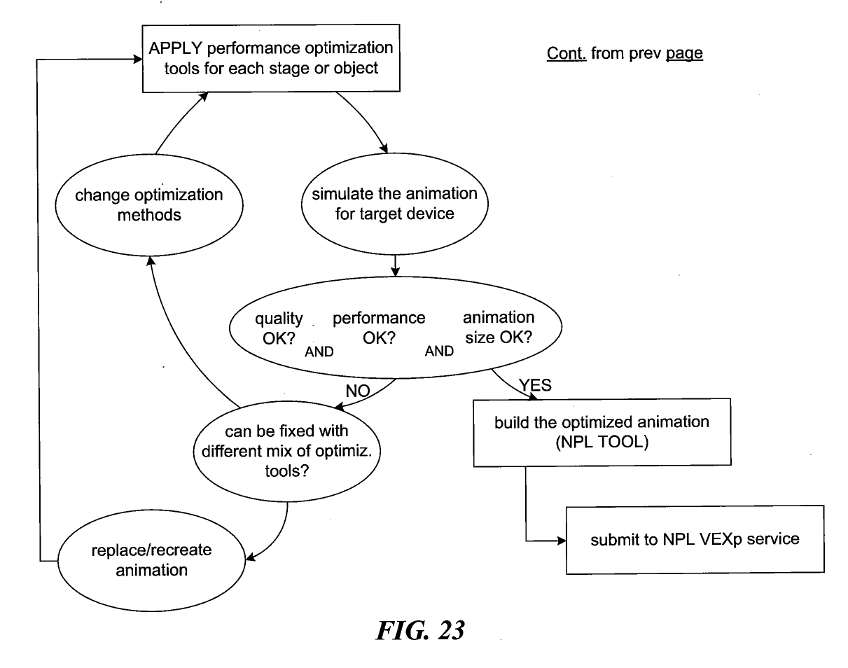

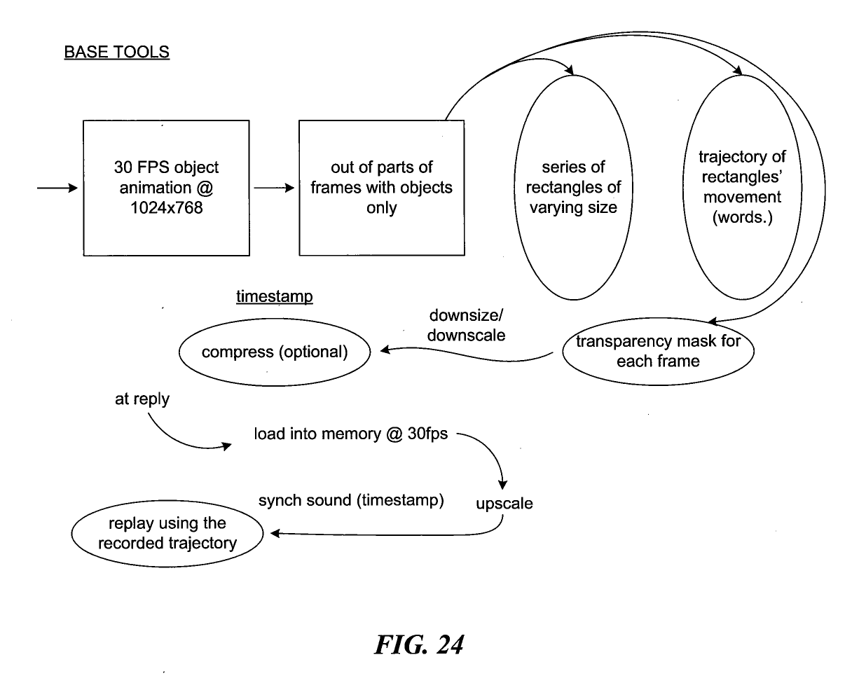

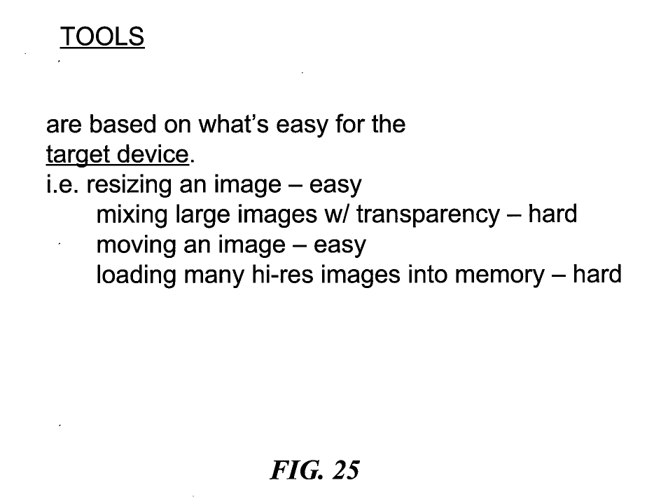

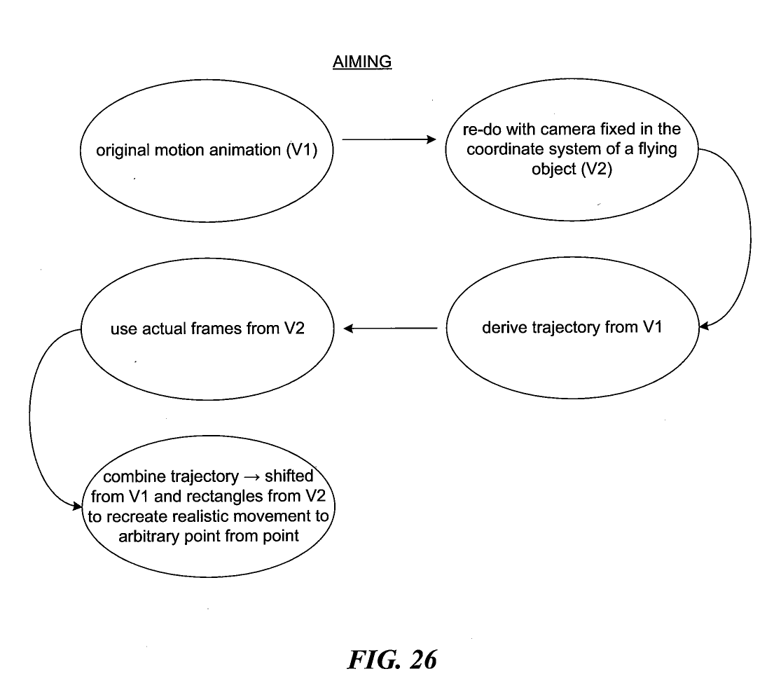

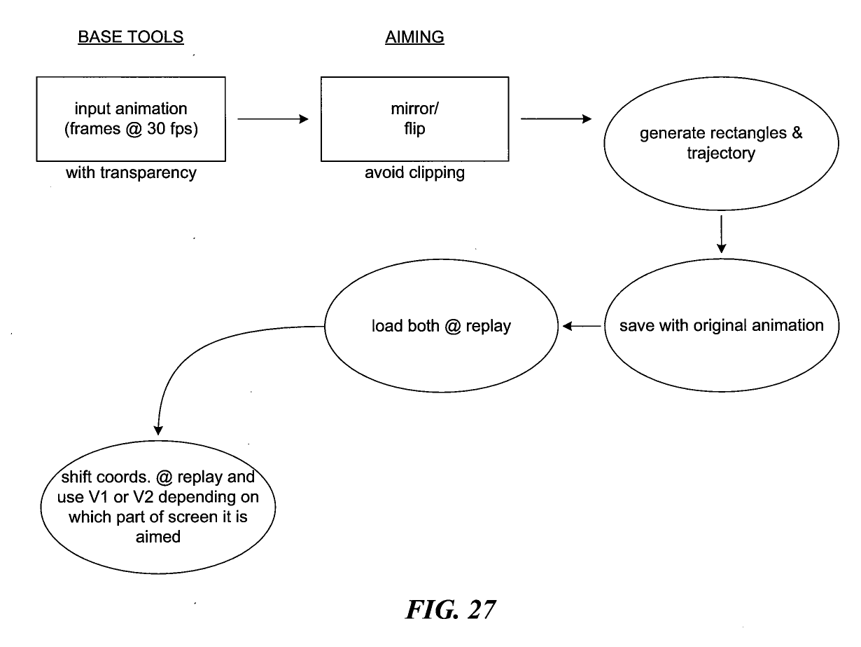

FIG. 22-23 further provide exemplary flow charts of workflows of creating and optimizing virtual experiences that may be integrated with the virtual experience engine. FIG. 24 provides an exemplary setup of base tools utilized in a virtual animation engine. FIG. 25 further provides additional details on animation rendering and further optimizing the created setup based on target devices where the animation is to be rendered. FIGS. 26-27 provide additional optimization examples based on the direction at which certain virtual experiences are aimed, and ensuring that trajectories and other dimensionalities associated with the aiming are efficiently translated based on the specific target device.

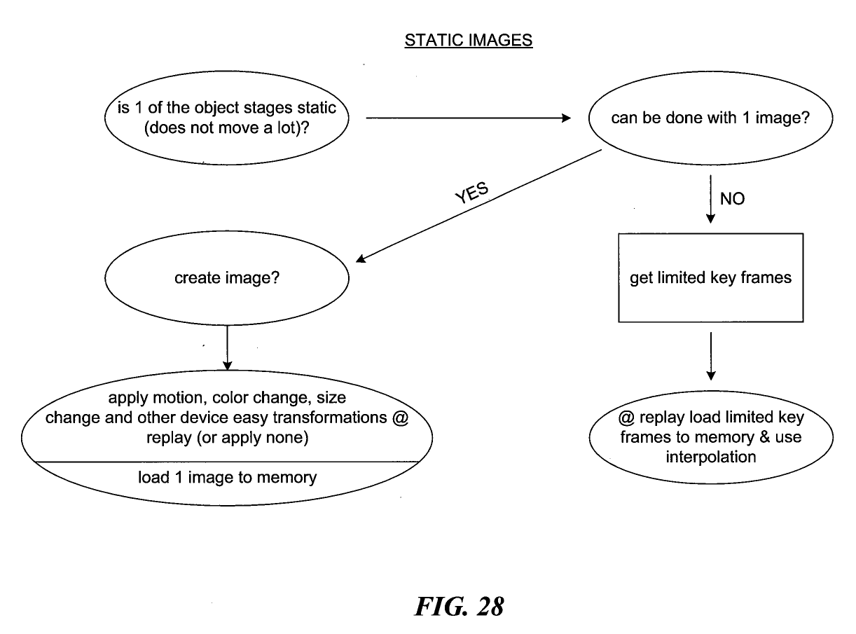

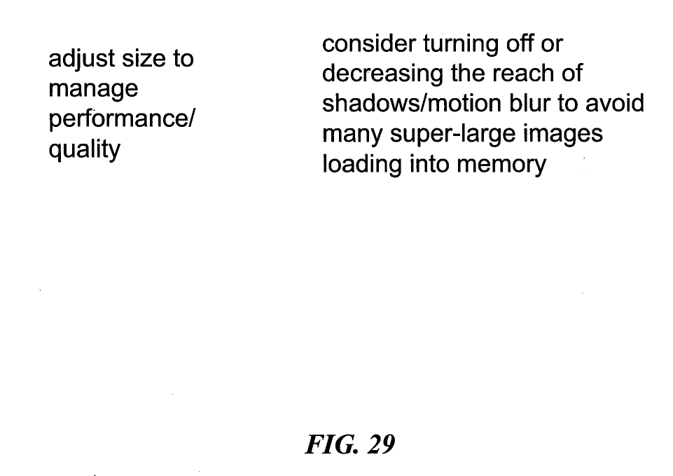

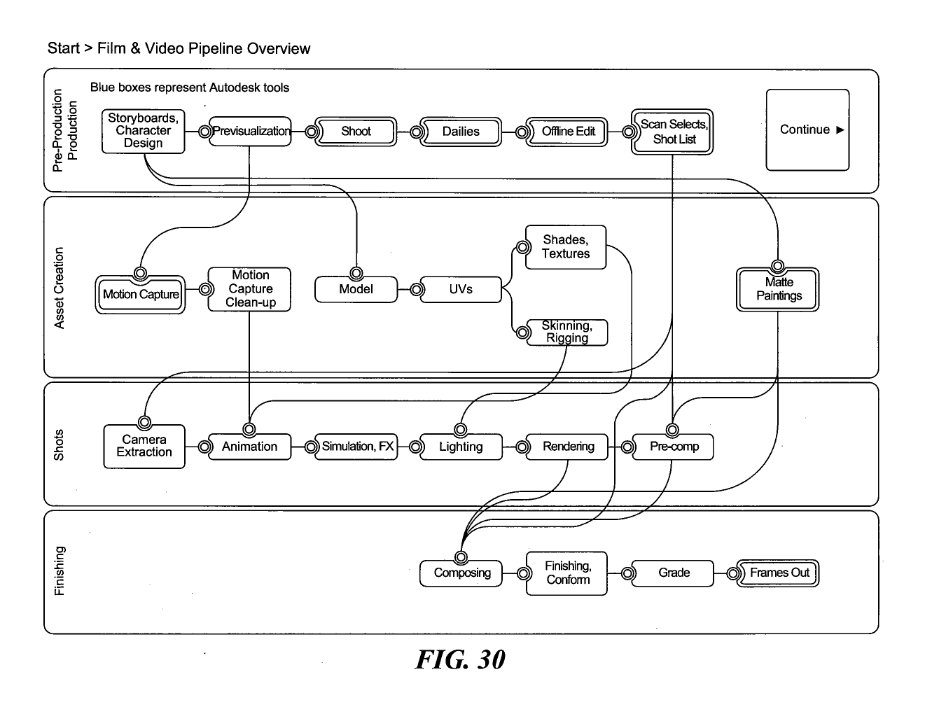

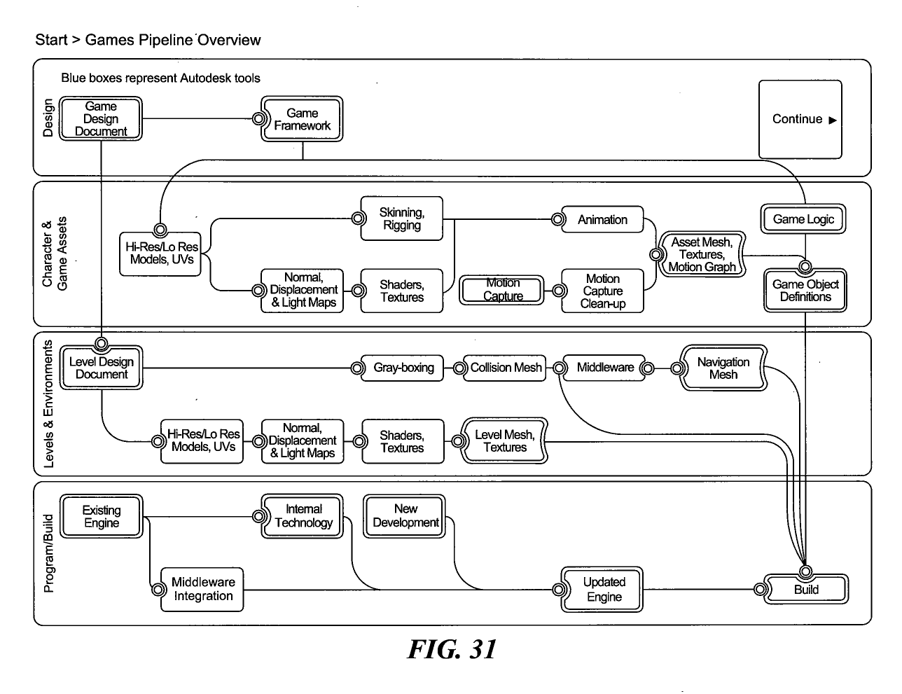

FIGS. 28-29 provide additional optimization examples that involve handling (e.g., resizing, changing file type, adapting resolution values, etc.) of images and other embodiments associated with virtual experiences based on target devices and availability of computing capabilities. In some embodiments, the resolution of static images and/or motion animations may be determined according to a plurality of factors. The plurality of factors may include available bandwidth of a low-latency network, a characteristic of the first participant's device, a characteristic of the recipient participant's device, and/or a characteristic of the virtual experience. FIGS. 30 and 31 further provide exemplary workflows of animation rendering and optimization to account for computing availability and based on target device specifications.

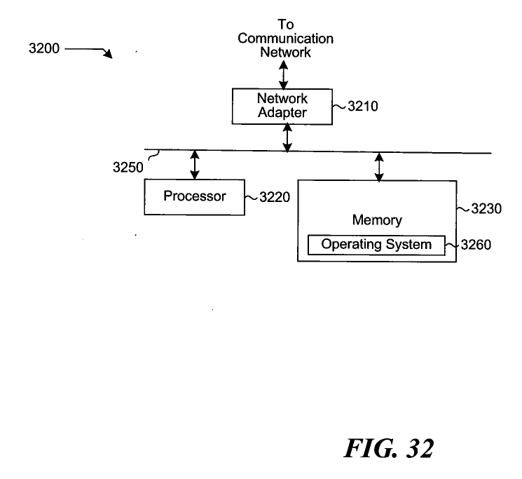

FIG. 32 illustrates an exemplary block diagram of the architecture for a virtual experience server 3200 for providing a virtual experience from a first participant to a second participant of an online event. The server 3200 includes one or more processors 3220 and one or more memory 3230 connected via an interconnect 3250. The interconnect 3250 is an abstraction that may represent any one or more separate physical data buses, point to point connections, or both connected by appropriate bridges, adapters, or controllers. Therefore, the interconnect 3250 may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The one or more processor(s) 3220 may include central processing units (CPUs) to control the operations of, for example, the host computer. In some embodiments, the processor(s) 3220 may accomplish the operations by executing software or firmware stored in the one or more memory 3230. The one or more processor(s) 3220 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The one or more memory 3230 may represent any form of random access memory (RAM), read-only memory (ROM), flash memory, or the like, or a combination of such devices. In use, the one or more memory 3230 may contain, among other things, a plurality of machine instructions which, when executed by the one or more processor(s) 3220, causes the one or more processor(s) 3220 to perform the operations to implement embodiments of the present disclosure.

The virtual experience server 3200 may also include a network adapter 3210, which is connected to the one or more processor(s) through the interconnect 3250. The network adapter 3210 may provide the virtual experience server 3200 with the ability to communicate with devices of online participants, remote devices (i.e., the storage clients), and/or other storage servers. The network adapter 3210 may be, for example, an Ethernet adapter or Fiber Channel Adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the present disclosure is not intended to be exhaustive or to limit the present disclosure to the precise form disclosed above. While specific examples for the present disclosure are described above for illustrative purposes, various equivalent modifications are possible within the scope of the present disclosure, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the present disclosure.

Any patents and applications and other references noted above, including any that may be listed in accompanying filing papers, are incorporated herein by reference. Aspects of the present disclosure can be modified, if necessary, to employ the systems, functions, and concepts included in such references to provide further implementations of the present disclosure.

These and other changes can be made to the present disclosure in light of the above Detailed Description. While the above description describes certain examples of the present disclosure, and describes the best mode contemplated, no matter how detailed the above appears in text, the present disclosure can be practiced in many ways. Details of the system may vary considerably in its specific implementation, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific examples disclosed in the specification, unless the above Detailed Description section explicitly defines such terms. Accordingly, the actual scope of the present disclosure encompasses not only the disclosed examples, but also all equivalent ways of practicing or implementing the present disclosure under the claims.

While certain aspects of the present disclosure are presented below in certain claim forms, the applicant contemplates the various aspects of the present disclosure in any number of claim forms. For example, while only one aspect of the present disclosure is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the present disclosure

In addition to the above mentioned examples, various other modifications and alterations of the present disclosure may be made without departing from the present disclosure. Accordingly, the above disclosure is not to be considered as limiting and the appended claims are to be interpreted as encompassing the true spirit and the entire scope of the present disclosure.

What is claimed is:

1. A computer implemented method of providing a virtual experience from a first participant to a recipient participant of an online event, the method comprising:
receiving the virtual experience from a device of the first participant, the virtual experience including a virtual goods component, an animation component, and an accompanying sound component, the animation component indicative of an idea the first participant intended to convey to the recipient participant;
generating the animation component of the virtual experience, the animation component including a graphical animation of the virtual goods component across displays of the first participant's device and the recipient participant's device;
and
providing the virtual experience to the recipient participant's device by spanning across the virtual goods component and the animation component with a trajectory starting from a display of the first participant's device and ending on a display of the recipient participant's device.

2. The method as recited in claim 1, wherein the virtual experience comprises dimensions including physicality, togetherness, real-time, emotion, and response time.

3. The method as recited in claim 2, wherein the virtual goods component includes one or more virtual goods that are purchased by the first participant.

4. The method as recited in claim 1, further comprising: encoding and decoding data streams of the virtual experience by using Sentio codecs in a low-latency network setup.

5. The method as recited in claim 4, wherein the Sentio Codecs are programmed according to a plurality of factors, the plurality of factors including available bandwidth, a characteristic of the first participant's device, a characteristic of the recipient participant's device, and/or a characteristic of the virtual experience.

6. The method as recited in claim 5, wherein the resolution of the animation component is determined according to the plurality of factors.

7. The method as recited in claim 1, wherein the virtual experience is activated or effectuated by a physical gesture of the first participant.

8. The method as recited in claim 7, wherein the trajectory is determined by the physical gesture of the first participant.

9. The method as recited in claim 7, wherein the trajectory is determined by a characteristic of the virtual goods component.

10. The method as recited in claim 7, further comprising: providing an option for the first participant to select the trajectory from a plurality of predetermined trajectories.

11. The method as recited in claim 1, wherein the virtual experience is activated or effectuated by controlling one or more buttons or keys on mobile device(s) of the first participant.

12. The method as recited in claim 1, wherein the accompanying sound component includes a swoosh noise following the trajectory, emulated splotching sound of the virtual good component hitting a screen of the recipient participant's device, and/or dripping sound of the splotched virtual good component.

13. A virtual experience server, the server comprising:
a network adapter configured to communicate with a plurality of participants' devices via a communication network; and
a memory, the memory coupled to the network adapter and configured to store computer code corresponding to operations for providing a virtual experience from a first participant to a recipient participant, the operations comprising:
receiving the virtual experience from a device of the first participant, the virtual experience including a virtual goods component, an animation component, and an accompanying sound component, the animation component indicative of an idea the first participant intended to convey to the recipient participant;
generating the animation component of the virtual experience, the animation component including a graphical animation of the virtual goods component across displays of the first participant's device and the recipient participant's device;
and
providing the virtual experience to the recipient participant's device by spanning across the virtual goods component and the animation component with a trajectory starting from a display of the first participant's device and ending on a display of the recipient participant's ‘device.

14. The virtual experience server as recited in claim 13, wherein the virtual experience comprises dimensions including physicality, togetherness, real-time, emotion, and response time.

15. The virtual experience server as recited in claim 14, wherein the virtual goods component includes one or more virtual goods that are purchased by the first participant.

16. The virtual experience server as recited in claim 13, wherein the operations further comprises: encoding and decoding data streams of the virtual experience by using Sentio codecs in a low-latency network setup.

17. The virtual experience server as recited in claim 16, wherein the Sentio Codecs are programmed according to a plurality of factors, the plurality of factors including available bandwidth, a characteristic of the first participant's device, a characteristic of the recipient participant's device, and/or a characteristic of the virtual experience.

18. The virtual experience server as recited in claim 17, wherein the resolution of the animation component is determined according to the plurality of factors.

19. The virtual experience server as recited in claim 13, wherein the virtual experience is activated or effectuated by a physical gesture of the first participant.

20. The virtual experience server as recited in claim 19, wherein the trajectory is determined by the physical gesture of the first participant.

21. The virtual experience server as recited in claim 19, wherein the trajectory is determined by a characteristic of the virtual goods component.

22. The virtual experience server as recited in claim 19, wherein the operations further comprises: providing an option for the first participant to select the trajectory from a plurality of predetermined trajectories.

23. The virtual experience server as recited in claim 13, wherein the virtual experience is activated or effectuated by controlling one or more buttons or keys on mobile device(s) of the first participant.

24. The virtual experience server as recited in claim 13, wherein the accompanying sound component includes a swoosh noise following the trajectory, emulated splotching sound of the virtual good component hitting a screen of the recipient participant's device, and/or dripping sound of the splotched virtual good component.

25. An apparatus for providing a virtual experience from a first participant to a recipient participant of an online event, the apparatus comprising:
means for receiving the virtual experience from a device of the first participant, the virtual experience including a virtual goods component, an animation component, and an accompanying sound component, the animation component indicative of an idea the first participant intended to convey to the recipient participant;
means for generating the animation component of the virtual experience, the animation component including a graphical animation of the virtual goods component across displays of the first participant's device and the recipient participant's device;
and
means for providing the virtual experience to the recipient participant's device by spanning across the virtual goods component and the animation component with a trajectory starting from a display of the first participant's device and ending on a display of the recipient participant's device.

26. A computer implemented method for providing a virtual experience to a specific participant of an online event, the method comprising:
receiving a request for the virtual experience from a device of the specific participant, the virtual experience including a virtual goods component, an animation component, and an accompanying sound component, the animation component indicative of an idea a transmitting participant intended to convey to a recipient participant;
searching the virtual experience on a local device of the specific participant and/or a cloud environment;
and
providing the virtual experience to the specific participant's device by spanning across the virtual goods component and the animation component with a trajectory across one or more relevant devices and ending on a display of the specific participant's device.

27. The method as recited in claim 26, wherein the virtual experience comprises dimensions including physicality, togetherness, real-time, emotion, and response time.

28. The method as recited in claim 26, further comprising: encoding and decoding data streams of the virtual experience by using Sentio codecs in a low-latency network setup.

29. The method as recited in claim 28, wherein the Sentio Codecs are programmed according to a plurality of factors, the plurality of factors including available bandwidth, a characteristic of the first participant's device, a characteristic of the recipient participant's device, and/or a characteristic of the virtual experience.

30. The method as recited in claim 29, wherein the resolution of the animation component is determined according to the plurality of factors.
